(19) United States
(12) Patent Application Publication
(10) Pub. No.: US 2008/0010527 A1
(43) Pub. Date: Jan. 10, 2008

(54) Method of solving BIST failure of CPU by means of BIOS and maximizing system performance

(75) Inventor: Ying-Chih Lu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/474,423

(22) Filed: Jun. 26, 2006

(51) Int. Cl. G06F 11/00

(52) U.S. Cl. 714/30

(57) ABSTRACT

The present invention is to provide a method of solving BIST (Build-in Self Test) failure of CPU (Central Process Unit) by means of BIOS (Basic Input/Output System) and maximizing system performance, which includes the steps of setting a flag representing each of the available CPUs in an MPS (multi-processor specification) table and an ACPI (advanced configuration power interface) table provided by the BIOS of a computer so as to inform OS (operation system) which logical CPUs are not BIST failure and available to be utilized by the OS. Therefore, the OS can fully utilize all logical CPUs passing the BIST so as to completely solve problems associated with BIST failure of CPU and maximize the performance of the computer system without involving any additional hardware circuit and setting a whole physical CPU as being disabled.

### FIELD OF THE INVENTION

The present invention relates to a method of solving BIST(Build-in Self Test) failure of CPU (Central Process Unit) by means of BIOS (Basic Input/Output System) and maximizing system performance, more particularly to a method capable of fully utilizing all logical CPUs passing the BIST to completely solve problems associated with BIST failure of CPU and maximize the performance of the computer system without involving any additional hardware circuit and setting a whole physical CPU as being disabled.

### BACKGROUND OF THE INVENTION

Many microelectronic devices (e.g., integrated circuits) are integrated into a single wafer of silicon (i.e., single chip) as VLSI (very large scale integration) technology has known a rapid, spectacular development in recent several decades. Thus, a single chip is able to process more calculation intensive operations. However, a number of problems are occurred in association therewith. It is thus impossible of guaranteeing quality of designed chips if integrated circuits are not tested in a well programmed, well defined test. SoC (system on a chip) technology has made phenomenal strides in recent years. Also, SoC is employed in the production of a variety of electronic products. SoC means that a system can be integrated into a single chip. A single chip may contain a great number of microelectronic devices including a CPU, input/output (I/O) units, and memory in which memory components occupy at least 80% of the total number of electronic devices. Also, the requirement for the amount of memory is increased gradually as the number of calculation intensive operations increases steadily. Hence, it is an important issue of how to effectively, successfully test memory in a SoC.

It is known that a SoC contains a great amount of memory of different types and sizes. Hence, there is no way of guaranteeing quality and efficiency of SoC if memory components are not tested effectively. Accordingly, a test technique called BIST is employed for parallel testing one of a great amount of memory of different sizes. BIST is embedded in SoC and is a self test for testing circuitry of SoC. BIST is able to greatly save test cost and significantly increase test speed.

Conventionally, CPU may take one of three actions in response to BIST failure in SoC as below.

(1) No action is taken for any BIST failure (i.e., no action).

(2) CPU records CPU BIST error(s) in an event log in response to BIST failure. Also, CPU BIST error(s) or a warning message is shown on a monitor screen when BIOS is running a POST (power on self test). Thus, a user is informed of same and is thus able to take any actions in response.

(3) A number of actions are taken in response to BIST failure. In detail, a physical CPU is set to a disabled state in response to CPU BIST failure. Also, the disabled state is recorded in an event log. A “CPU BIST failure” warning message is logged or shown by BMC (baseboard management controller) or when BIOS is running a POST. Thus, a user is informed of same and is thus able to take any subsequent actions in response. These actions are able to solve some problems for CPU when BIST failure occurs. However, a couple of major drawbacks still exist as follows.

(i) Additional hardware circuit is required to disable a CPU in response to BIST failure. Typically, a pin of GPO (general purpose output) is connected to a pin labeled “SMI#” of a physical CPU (note that there is only one pin labeled “SMM#” in a physical CPU) for disabling the physical CPU. Most pins of GPO are controlled by BMC. Thus, additional hardware circuit is required to disable a physical CPU. This inevitably will greatly increase design and manufacturing costs.

(ii) The whole physical CPU (i.e., dual core) and hyper-threading are disabled. And in turn, logical CPU of a good physical CPU (i.e., without fail after BIST) is no longer useful. As a result, system performance is degraded. Based on definitions of CPU pins, in a case of signal of “Reset#” pin of CPU being active, all pins of a physical CPU are in tri-state (i.e., the physical CPU no longer exists) when signal of pin labeled “SMI#” is low by sampling. That is, the physical CPU is set as being disabled. It is known that a physical CPU has only one pin labeled “SMI#”. Thus, all logical CPUs inside the physical CPU are set as being disabled in response to the setting of the physical CPU as being disabled. As an end, system performance is degraded greatly.

Thus, it is desirable among SoC manufacturers of the art to design a SoC capable of running a POST without involving any additional hardware circuit, and only setting a failed logical CPU as being disabled in response to CPU BIST failure rather than setting the whole physical CPU as being disabled, thereby effectively decreasing design and manufacturing costs, enabling OS (operation system) to fully employing other logical CPUs without fail after BIST, and maximizing system performance.

### SUMMARY OF THE INVENTION

After considerable research and experimentation, a method of solving BIST failure of CPU by means of BIOS and maximizing system performance according to the present invention without involving any additional hardware circuit and without setting a whole physical CPU as being disabled has been devised so as to overcome the above drawbacks of the prior art SoC.

In one aspect of the present invention BIOS of a computer system is employed to command a BSP of the computer system to transmit initial check messages (e.g., INIT IPI and Startup IPI) and SIPI messages to all APs to obtain BIST state values of the APs. The BIST state values are created by automatically executing BIST by the CPU in CPU hard reset. Next, set a flag representing each of the available CPUs in an MPS table and an ACPI table provided by the BIOS. The OS is thus informed of those logical CPUs of not BIST failure available to the OS. Therefore, the OS can fully utilize all logical CPUs passing the BIST so as to completely solve problems associated with BIST failure of CPU and maximize the performance of the computer system.

In another aspect of the present invention a logical CPU of BIST failure is set as being disabled by means of BIOS without setting a whole physical CPU as being disabled. As an end, any additional hardware circuit is not required and problems associated with BIST failure of CPU are completely solved.

The above and other objects, features and advantages of the present invention will become apparent from the following detailed description taken with the accompanying drawings.

### BRIEF DESCRIPTION OF THE DRAWINGS

FIG. 1 schematically depicts hyper-threading of physical CPUs and associated logical CPUs as supported by a computer system according to a first preferred embodiment of the invention;

FIG. 2 schematically depicts hyper-threading and dual core of physical CPUs and associated logical CPUs as supported by a computer system according to a second preferred embodiment of the invention; and

FIG. 3 is a flowchart depicting a process according to the invention.

### DETAILED DESCRIPTION OF THE PREFERRED EMBODIMENTS

Preferred embodiments of the invention are discussed below by means of a computer system having two CPU sockets. Each CPU mounted on the socket can support hyper-threading. Also, a user is required to either mount two physical CPUs having the same CPU ID (identification) on the socket or mount a physical CPU on the computer system.

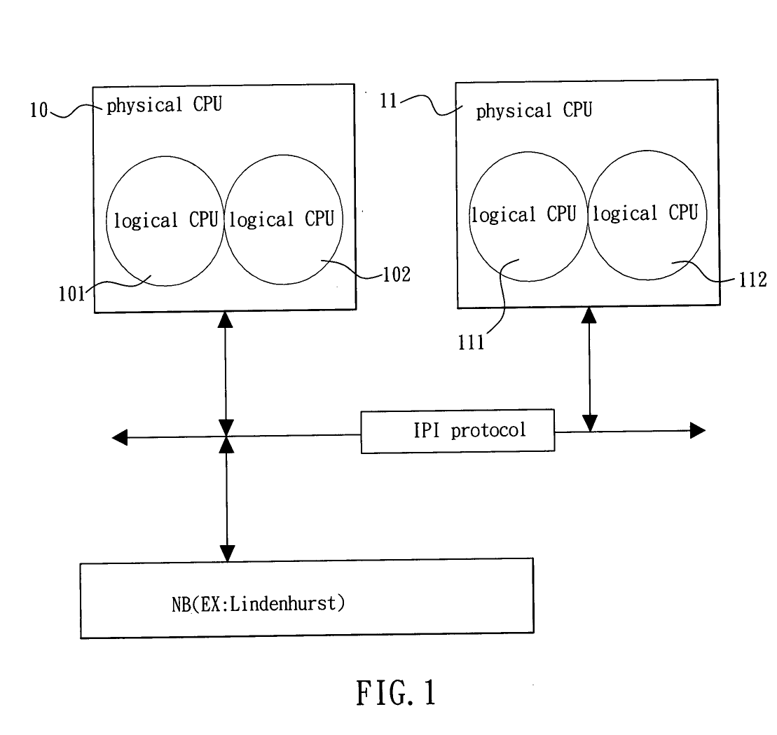

Referring to FIG. 1, a first preferred embodiment of computer system according to the invention is shown. The computer system comprises two mounted physical CPUs 10 and 11 each having two logical CPUs. In other words, the computer system has four logical CPUs 101, 102, 111, and 112 at most. Each of the logical CPUs 101, 102, 111, and 112 has a local APIC (advanced programmable interrupt controller) which has an ID (i.e., local APIC ID). The local APIC ID is adapted to identify a logical CPU when the logical CPU communicates an IPI (inter-processor interrupt) protocol message. In other words, a local APIC ID represents a logical CPU. A common host bus is interconnected the logical CPUs 101, 102, 111, and 112. Also, an IPI protocol is provided to communicate among the logical CPUs 101, 102, 111, and 112. The IPI protocol is adapted to create a plurality of IPI messages each including a local APIC ID field for representing a destination logical CPU 101, 102, 111 or 112. A local APIC ID of each of the logical CPUs 101, 102, 111, and 112 is determined by wiring some pins of CPU. For example, a local APIC ID is determined by BRO pin if the computer system having two physical CPU sockets. Also for example, a local APIC ID is determined by BR0 pin and BR1 pin if the computer system having four physical CPU sockets and so on. A local APIC ID is automatically recorded in a register of a logical CPU when a computer system powers on.

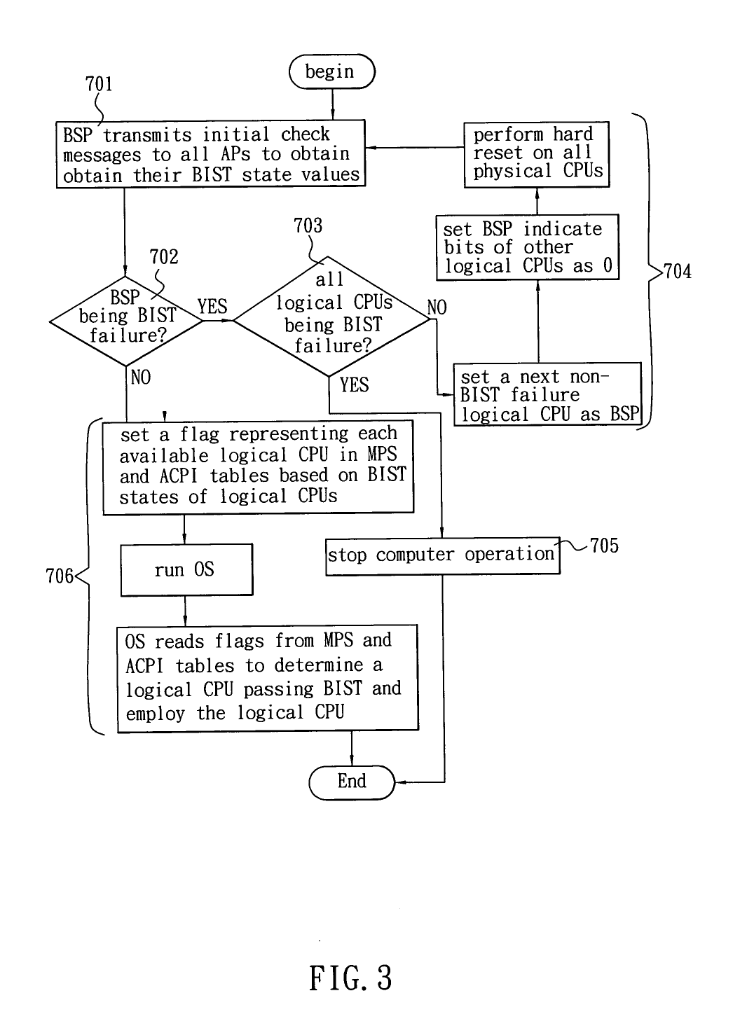

In the embodiment, BIOS of a computer system is initialized when an event occurs. For example, the event can be power on or CPU hard reset. Each of the logical CPUs 101, 102, 111, and 112 performs a BIST and performs a symmetric arbitration mechanism over the common host bus. The logical CPU 101, 102, 111, or 112 belonging to the winner of the mechanism is set as a BSP (bootstrap processor). At this time, the logical CPU 101, 102, 111, or 112 as BSP executes a memory fetch cycle so as to fetch an instruction from a BIOS flash ROM (Read-Only Memory) of BIOS and perform same. The instruction is a first instruction fetched by CPU after hard reset. Referring to a process in the flowchart of FIG. 3, the computer system thereafter performs the following steps:

In step 701, the BSP (e.g., the first logical CPU 101) transmits initial check messages (e.g., INIT IPI and Startup IPI) and SIPI (startup inter-processor interrupt) messages to all APs (application processors) (e.g., the second, the third, and the fourth logical CPUs 102, 111, and 112, i.e., all non-BSP logical CPUs) in order to obtain BIST state values of the logical CPUs 102, 111, and 112 of the APs. Note that after powering on the computer system, the BSP (e.g., the first logical CPU 101) is BIST failure if a value stored in an EAX (extended accumulate) register of the BSP is not zero.

In step 702, it is determined whether the BSP (e.g., the first logical CPU) is a BIST failure or not. If yes, the process goes to step 703. Otherwise, the process jumps to step 706.

In step 703, it is determined whether all of the logical CPUs 101, 102, 111, and 112 are BIST failure or not. If yes, the process jumps to step 705. Otherwise, the process goes to step 704.

In step 704, set a BSP indicate bit of a next non-BIST failure logical CPU (e.g., the third logical CPU 111) as one (1) to have it as a BSP of the computer system, and set BSP indicate bits of other logical CPUs (e.g., the first, the second, and the fourth logical CPUs 101, 102, and 112) as zero (0). Next, perform a hard reset on all physical CPUs. The process then loops back to step 701.

In step 705, halt the computer system and create a warning message and show same on a monitor screen connected to the computer system. As such, a user can be informed of same.

In step 706, set a flag representing each of the available logical CPUs in an MPS (multi-processor specification) table and an ACPI (advanced configuration power interface) table provided by BIOS, and run an OS of the computer system. Then, the OS reads flags from the MPS table or the ACPI table in order to correctly determine a logical CPU that passes a BIST. Thereafter, employ the logical CPU to maximize system performance.

In the above step 706, a flag of a logical CPU corresponding to any logical CPU of BIST failure will be set as zero (0). To the contrary, a flag a logical CPU corresponding to any logical CPU of BIST success will be set as one (1).

It is noted that in the step 704 the logical CPUs are selected as BSPs based on a sequence of the first logical CPU 101, the third logical CPU 111, the second logical CPU 102, and the fourth logical CPU 112. It is further noted that the sequence is only implemented by a preferred embodiment of the invention. Other sequences are possible and are within the scope of the invention set forth in the claims as long as they configure a next non-BIST failure logical CPU as a BSP by complying with the description in step 704.

In the embodiment, a description of how to enable a logical CPU which has the support of hyper-threading is described below. In response to running OS of a computer system, the OS is adapted to obtain the number of CPUs from MPS table or ACPI table. Also, different values are obtained as shown in the following table based on a BIST state of each logical CPU in which each of ID#0, ID#1, ID#6, and ID#7 represents a local APIC ID of each of the logical CPUs 101, 102, 111, and 112 respectively, F represents a logical CPU of BIST failure, G(B) represents a logical CPU of not BIST failure (i.e., passing BIST) and being set as BSP, G represents an AP of not BIST failure, and a numeral between two parentheses represents the number of available CPUs as well known in the art. Note that in the embodiment flags of MPS table are set based on BIST states of ID#0 and ID#6, but ID#1 and ID#7 are non-available logical CPUs due to restrictions between some CPUs and the OS. However, there is no such restriction in ACPI table.

| ID# 0 | ID# 1 | ID# 6 | ID# 7 | CPU# in MPS | CPU# in ACPI |
|---|---|---|---|---|---|
| F | F | F | F | 0 (0) | 0 (0) |
| F | F | F | G (B) | 0 (0) | 1 (0) |
| F | F | G (B) | F | 1 (0) | 1 (0) |
| F | F | G (B) | G | 1 (1) | 2 (2) |
| F | G (B) | F | F | 0 (0) | 1 (0) |
| F | G (B) | F | G | 0 (0) | 2 (0) |
| F | G | G (B) | F | 1 (0) | 2 (0) |
| F | G | G (B) | G | 1 (1) | 3 (2) |
| G (B) | F | F | F | 1 (0) | 1 (0) |
| G (B) | F | F | G | 1 (0) | 2 (0) |
| G (B) | F | G | F | 2 (0) | 2 (0) |
| G (B) | F | G | G | 2 (1) | 3 (2) |
| G (B) | G | F | F | 1 (1) | 2 (2) |
| G (B) | G | F | G | 1 (1) | 3 (2) |
| G (B) | G | G | F | 2 (1) | 3 (2) |
| G (B) | G | G | G | 2 (2) | 4 (4) |

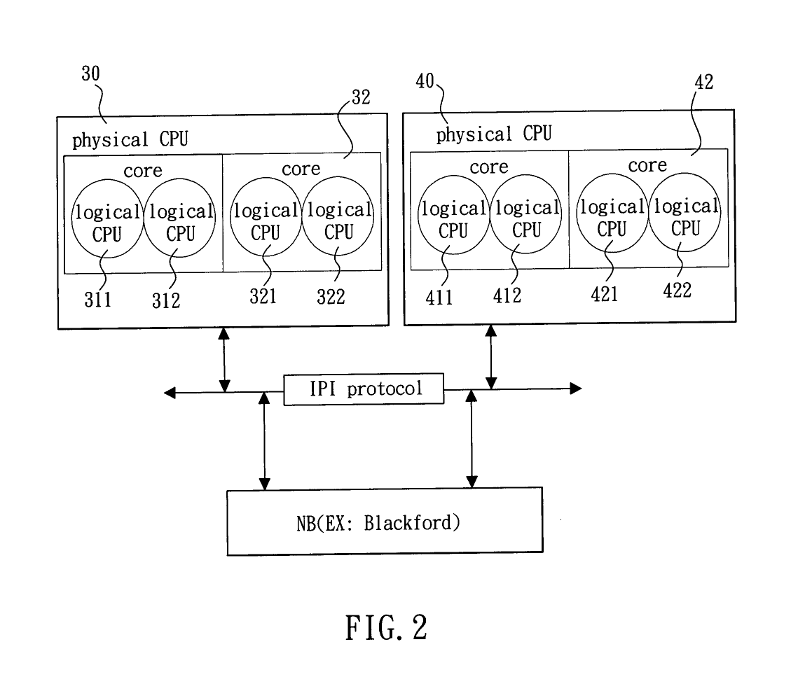

In a second preferred embodiment of the invention, a computer system having two CPU sockets will be discussed in detail below. A CPU mounted on the socket can not only support hyper-threading but also support dual core by referring to FIG. 2. As shown, the computer system comprises two mounted physical CPUs 30 and 40 each having two cores. Each core comprises two logical CPUs. Thus, in the embodiment the computer system has eight (8) logical CPUs 311, 312, 321, 322, 411, 412, 421, and 422 at most in which a local APIC ID of each of the logical CPUs 311, 312, 321, and 322 is 0, 1, 2, and 3 respectively, and a local APIC ID of each of the logical CPUs 411, 412, 421, and 422 is 4, 5, 6, and 7 respectively. Thus, in a case of all CPUs supporting dual core and hyper-threading being enabled and powering on a computer system, BSP of the computer system performs operations as detailed in steps of FIG. 3. In the embodiment, a sequence of the logical CPUs is logical CPU 311, logical CPU 411, logical CPU 321, logical CPU 421, logical CPU 312, logical CPU 412, logical CPU 322=, and logical CPU 422 which is implemented in performing operations. After running the OS, the OS is adapted to obtain the number of CPUs from MPS table or ACPI table. Also, different values are obtained as shown in the following table based on a BIST state of each logical CPU in which each of ID#0, ID#1, ID#2, ID#3, ID#4, ID#5, ID#6, and ID#7 represents a local APIC ID of each of the logical CPUs 311, 312, 321, 322, 411, 412, 421, and 422 respectively, and a numeral between two parentheses represents the number of available CPUs as well known in the art.

It is noted that in the embodiment flags of MPS table are set based on BIST states of ID#0, ID#2, ID#4, and ID#6, but ID#1, ID#3, ID#5, and ID#7 are non-available logical CPUs due to restrictions between some CPUs and the OS. However, there is no such restriction in ACPI table. Further, there are 256 entries in the following table. However, an excessive amount of space may be consumed if all of 256 entries are listed. Hence, only some representative entries are listed below.

Those skilled in the art may easily understand other omitted entries herein by referring to the following entries.

| ID# 0 | ID# 1 [symbol] 4 | ID# 5 | ID# 6 | ID# 7 | CPU# in MPS | CPU# in ACPI |
|---|---|---|---|---|---|---|
| G (B) | G | G | G | G | 4 (4) | 8 (8) |
| G (B) | G | G | G | F | 4 (2) | 7 (4) |
| G (B) | G | G | F | G | 3 (2) | 7 (4) |
| G (B) | G | G | F | F | 3 (2) | 6 (4) |
| G (B) | G | F | G | G | 4 (2) | 7 (4) |
| G (B) | G | F | G | F | 4 (2) | 6 (4) |
| G (B) | G | F | F | G | 3 (2) | 6 (4) |
| . . . | . . . | . . . | . . . | . . . | . . . | . . . |
| F | F | F | F | F | 0 (0) | 0 (0) |

Hence, for two physical CPUs supporting hyper-threading in the first embodiment of the invention, a logical CPU (e.g., local APIC ID#00 or local APIC ID#06) is enabled therein. The logical CPU (e.g., local APIC ID#00) selected as BSP is listed as a configuration table entry in the following MPS table in which CPU Bootstrap field has a flag of one (1).

Entry in MP Configuration Table for the BSP Logical Processor

| | | | | | |
|---|---|---|---|---|---|
| LocalAPICID | 00 | CPUEnable | 1 | Stepping | 3 |
| LocalAPICVersion | 14h | CPUBootStrap | 1 | Model | 4 |
| MCE | 1 | CX8 | 1 | Family | f |
| FPU | 1 | APIC | 1 | | |

The other logical CPU (e.g., local APIC ID#06) not selected as BSP is listed as a configuration table entry in the following MPS table in which CPU Bootstrap field has a flag of zero (0).

Entry in MP Configuration Table for the AP Logical Processor

| | | | | | |
|---|---|---|---|---|---|
| LocalAPICID | 06 | CPUEnable | 1 | Stepping | 3 |
| LocalAPICVersion | 14h | CPUBootStrap | 0 | Model | 4 |
| MCE | 1 | CX8 | 1 | Family | f |
| FPU | 1 | APIC | 1 | | |

For two physical CPUs supporting hyper-threading in the first embodiment of the invention, only one physical CPU is enabled (i.e., two logical CPUs such as APIC ID#00 and APIC ID#01 are enabled) and the other two logical CPUs (e.g., APIC ID#06 and APIC ID#07) are disabled. Multi-processor entry of a logical CPU having an APIC ID of “00” in ACPI table is listed below.

| | |
|---|---|
| Processor Local APIC | 00 |
| length | 08 |
| ACPI Processor ID | 01 |
| APIC ID | 00 |
| Flags (0 = proc unusable) | 00000001 |

Multi-processor entry of a logical CPU having an APIC ID of “01” in ACPI table is listed below.

| | |
|---|---|
| Processor Local APIC | 00 |
| length | 08 |
| ACPI Processor ID | 02 |
| APIC ID | 01 |
| Flags (0 = proc unusable) | 00000001 |

Multi-processor entry of a logical CPU having an APIC ID of “06” in ACPI table is listed below.

| | |
|---|---|
| Processor Local APIC | 00 |
| length | 08 |
| ACPI Processor ID | 03 |
| APIC ID | 06 |
| Flags (0 = proc unusable) | 00000000 |

Multi-processor entry of a logical CPU having an APIC ID of “07” in ACPI table is listed below.

| | |
|---|---|
| Processor Local APIC | 00 |
| length | 08 |
| ACPI Processor ID | 04 |
| APIC ID | 07 |
| Flags (0 = proc unusable) | 00000000 |

In view of above, it is contemplated by the invention that a logical CPU of BIST failure set as being disabled by means of BIOS without involving any additional hardware circuit and without setting a whole physical CPU as being disabled. Also, flags representing the number of available CPUs in MPS table and ACPI table are set. Hence, an OS may read flags from the MPS table or the ACPI table in order to know whether there are any logical CPUs of not BIST failure available to the OS. Thereafter, all logical CPUs of not BIST failure can be fully employed. As an end, problems associated with BIST failure of CPU are completely solved and system performance is therefore maximized.

While the invention herein disclosed has been described by means of specific embodiments, numerous modifications and variations could be made thereto by those skilled in the art without departing from the scope and spirit of the invention set forth in the claims.

What is claimed is:

1. A method of solving BIST (built-in self test) failure of a CPU (central processing unit) by means of a BIOS (basic input/output system) of a computer system and maximizing performance of the computer system comprising the steps of:
setting one of at least two logical CPUs of a physical CPU mounted in the computer system as a BSP (bootstrap processor) of the computer system by operating the BIOS of the computer system;
setting any remaining logical CPU as an AP (application processor) of the computer system;
setting a flag representing each of the available logical CPUs in an MPS (multi-processor specification) table and an ACPI (advanced configuration power interface) table provided by the BIOS,
setting each of the logical CPUs of BIST failure as a disabled one;
running an OS (operation system) of the computer system to read the flags from the MPS table or the ACPI table;
determining whether there is any logical CPU that passes a BIST; and
causing the OS to employ the logical CPU that passes a BIST.

2. The method of claim 1, wherein the BIOS further comprises performing the steps of:
causing the BSP to transmit initial check messages to all of the APs; and
causing the BSP to transmit SIPI (startup inter-processor interrupt) messages to all of the APs for obtaining BIST state values of the APs.

3. The method of claim 2, wherein the BIOS further comprises performing the steps of:
determining whether the BSP is a BIST failure or not; and
when the BSP is not a BIST failure, setting a flag representing each of a plurality of available processors in the MPS table and the ACPI table based on BIST state values of the processors.

4. The method of claim 2, wherein the BIOS further comprises performing the steps of:
determining whether the BSP is a BIST failure or not; and
when the BSP is a BIST failure, determining whether all of the APs are BIST failure or not; and
when not all of the APs are BIST failure, selecting a next non-BIST failure logical CPU as a BSP of the computer system by performing the steps of claim 1 for obtaining BIST state values of the APs.

5. The method of claim 2, wherein the BIOS further comprises performing the steps of:
determining whether the BSP is a BIST failure or not; and
when the BSP is a BIST failure, determining whether all of the APs are BIST failure or not; and
when all of the APs are BIST failure, stopping the computer system and issuing a warning message.
